(19) United States
(12) Patent Application Publication
(10) Pub. No.: US 2024/0116617 A1
(43) Pub. Date: Apr. 11, 2024

(54) MOUNTING DEVICE FOR A JOYSTICK CONFIGURED FOR CONTROLLING A VEHICLE

(71) Applicants: ZF Friedrichshafen AG, Friedrichshafen (DE); ZF Padova S.r.l., Caselle die Selvazzano (PD) (IT)

(72) Inventors: Paolo Moruzzi, Caselle di Selvazzano(PD) (IT); Massimo Tranquillini, Mori (TN) (IT); Ferruccio Basurto, Caselle di Selvazzano (PD) (IT); Gianluca Straccio, Caselle di Selvazzano (PD) (IT); Danilo Selvaggi, Caselle di Selvazzano (PD) (IT)

(73) Assignees: ZF Friedrichshafen AG, Friedrichshafen (DE); ZF Padova S.r.l., Caselle die Selvazzano (PD) (IT)

(21) Appl. No.: 18/480,780

(22) Filed: Oct. 4, 2023

(30) Foreign Application Priority Data
Oct. 10, 2022 (EP) 22200671.0

(51) Int. Cl. B63H 21/21; G05G 5/04; G05G 5/05; G05G 9/047; G05G 25/04

(52) U.S. Cl. CPC B63H 21/213; G05G 5/04; G05G 5/05; G05G 9/047; G05G 25/04; B63H 2021/216; G05G 2009/04725; G05G 2009/04774; G05G 2505/00

(57) ABSTRACT

The present invention relates to a mounting device (30) for a joystick (10), the mounting device (30) comprising a first and second mounting element (32, 34), a spring element (36) and a ball element (38). The two mounting elements (32, 34) are rotatably attached to allow rotation of the joystick (10) about a central axis (22) of yaw rotation. The spring element (36) is mounted to the first mounting element (32) and urges the ball element (38) against a ball support surface (50) of the second mounting element (34). The ball support surface (50) is inclined such that rotation of the stick element (16) about the central axis (22) away from a neutral yaw position causes increase of tension in the spring element (36), biasing the joystick (10) towards the neutral yaw position. Further, the invention relates to a joystick (10) and a marine vessel.

### TECHNICAL FIELD

The present invention relates to a mounting device for a joystick configured for controlling a vehicle, such as a marine vessel. Further, the invention relates to a joystick configured for controlling a vehicle.

### PRIOR ART

Joysticks are a form of control device that can be used to control vehicles. For example, a joystick may be very convenient for controlling an outboard engine of a boat since such engines are not mounted fixedly in place but rather need to be adjusted to the current riding state, such as speed, loads and waves. Similarly, large ships, yachts and special purpose boats may have propeller pods or lateral thrusters to allow higher maneuverability that may be suitable controlled by the multiple movement axis of a joystick. However, providing adequate functionality in a cost-effective manner while having a design suitable for maritime environments is difficult.

The stick element of such a joystick can be rotatable around a yaw axis. The yaw axis usually corresponds to a longitudinal axis of the joystick and extends substantially upright if the joystick is in a neutral position. If the stick element is rotated about the yaw axis to deflect the joystick out of its neutral yaw position, a sensor captures said movement for creating a vehicle control signal. Once the joystick is released, a return to its neutral yaw position is usually desired. Providing an appropriate mounting device that provides such a functionality is difficult, especially if the joystick can be rotated around the yaw axis in two directions of rotation from its neutral jaw position.

WO 2006/062416 A1 describes a propulsion and control system for a marine vessel. A control element of the system is mounted to a rotary potentiometer that has a spring-to-center mechanism and is arranged to generate a Z-axis signal representing the rotation of the control element about the Z-axis from a neutral position. Such a spring-to-center mechanism is complex and cost-intensive, for example due to the integration in the potentiometer and the use of non-standard parts. Further, the mechanism requires a rather large installation space and the custom construction cannot easily be adapted to different marine vessels. In addition, in case of uneven wear of the spring mechanism, the control element may not fully return to the neutral position, resulting in possible erroneous control commands.

### SUMMARY OF THE INVENTION

A first aspect relates to a mounting device for a joystick for controlling a vehicle. The joystick may comprise a stick element, which may be configured to be grasped by a hand. The mounting device may be configured to allow tilting of the stick element left-right, forward-backwards and a combination thereof. In addition, the mounting device may be configured to allow rotation of the stick element around a yaw axis, which may correspond to a longitudinal axis of the stick element. Each movement axis may control different functions of the vehicle, such as its propulsion system and alternatively or additionally its steering. The joystick may comprise additional control elements, such as buttons, which may be arranged on the stick element and additionally or alternatively on a base of the joystick. The vehicle may be configured as a marine vessel, such as a speedboat, yacht or special purpose ship. Alternatively, the vehicle may also be configured as land-bound vehicle, such as an agricultural vehicle or industrial truck.

The mounting device comprises a first mounting element, a second mounting element, a spring element and a ball element. One of the two mounting elements may be configured for mounting to the vehicle, for example for fixed mounting to the vehicle. The other of the two mounting elements may be moveably attached to the other mounting element. Said mounting element may be configured for attachment of the stick element. The joystick may comprise a stick element attached to one mounting element that is moveably supported by a base that comprises the other mounting element. The mounting element that forms part of the base may be moveably mounted in a base element, for example allowing further degrees of freedom for movement of the stick element, such as forward and backward tilting. The spring element may be configured as a compression spring. For example, the spring element may be configured as coil spring, such as a metal coil spring. The ball element may be a metal or plastic ball, for example configured as a roller typically found in roller bearings. The ball element may, for example, be configured as a sphere or as a cylinder. The ball element may thus be a cost-effective standard component. Similarly, the spring element may also be a cost-effective standard component. A diameter of the ball element may correspond to a diameter of the spring element.

The two mounting elements are rotatably attached to each other to allow a rotation of a stick element of the joystick about a central axis of yaw rotation out of a neutral yaw position. The mounting device may be configured to allow rotation away from the neutral yaw position in two directions, such as a left and right direction, or just one direction. The stick element may be configured as a bar extending from the mounting device. Alternatively, the stick element may also be formed as a cap, for example partially extending over the mounting device. Such a configuration may be very compact. Further, it may provide additional protection for the mounting device.

The central axis may be coaxial to the yaw rotation axis and additionally or alternatively to the longitudinal axis of the stick element. The central axis may be an axis of symmetry of the mounting device or might be off-set from such an axis of symmetry. When mounted to the vehicle, the yaw rotation axis usually extends upright, for example substantially vertical in most vehicles. The neutral yaw position may be a position in which the joystick does not generate any command signal for the vehicle function controlled by yaw deflection of the joystick. For example, in the neutral yaw position, lateral thrusters of a ship do not create any thrust. The joystick may be configured to automatically return to the neutral yaw position upon its release. The joystick may be configured to automatically return to a neutral position from a tilted position in other degrees of freedom upon its release

The spring element is mounted to the first mounting element and urges the ball element against a ball support surface of the second mounting element. The first mounting element may either be a stick side mounting element, for example supporting the stick element, or a vehicle side mounting element, for example configured to be fixedly attached to the vehicle. The second mounting element may thus either be the vehicle side mounting element or the stick side mounting element, depending on which of the two the first mounting element is.

The spring element may be fixed with one end to the first mounting element. The spring element may also just be arranged between a spring support surface of the first mounting element and the ball element. The spring element may be facing towards the ball element with an end opposite the first mounting element, for example touching the ball element with this end. The spring element may be received in a blind hole of the first mounting element. The spring element may extend from the blind hole towards the second mounting element, towards the ball support surface and alternatively or additionally the ball element. The spring element may be arranged eccentrically to the central axis. The spring element may be arranged spaced apart to the central axis of yaw rotation. The spring element may extend parallel to the central axis and additionally or alternatively the longitudinal axis of the stick element. The spring element may be tensioned in any position of the first mounting element relative to the second mounting element, for example pressing against the ball element.

The ball support surface of the second mounting element may be a surface facing towards the first mounting element, the spring element and additionally or alternatively the ball element. The ball support surface may, for example, be a section of an annular surface or a section of a round surface. The ball element may be supported by the ball support surface in any yaw position of the joystick. The ball element may be arranged on the same axis as the spring element. The ball element may remain in contact with the spring element regardless of yaw position. The ball element may move together with the first mounting element and thus the spring element. For example, the ball element may move along the ball support surface when the stick element is twisted yaw wise about the central axis. The ball element may roll and alternatively or additionally slide over the ball support surface when the first mounting element is rotated relative to the second mounting element.

At least part of the ball support surface is inclined such that rotation of the stick element about the central axis away from the neutral yaw position causes increase of tension in the spring element. This increase in tension provides a return force for rotating the stick element back into the neutral position upon release. The return force may be defined by the construction and may be depending on a yaw angle relative to the neutral yaw position. The incline and the energy stored in the spring element cause the ball element to roll and alternatively or additionally slide back towards a position corresponding to the neutral yaw position. The mounting device may bias the joystick towards its neutral yaw position. The return force may increase with larger deflection from the neutral yaw position, providing a tactile feedback to the operator. Due to the use of an inclined surface instead of counteracting springs, the mounting device has a high reliability of returning the joystick to the neutral position even if two directions of yaw rotation are possible and even if the spring element changes its spring characteristics due to wear. In addition, less spring elements may be required.

The inclined part of the ball support surface may be planar or curved. For example, the inclination may increase the further the surface is away from a section corresponding to the neutral yaw position. The ball support surface may comprise several inclined surface parts. The ball support surface may also comprise non-inclined parts, such as at a section on which the ball element rests in the neutral yaw position.

The neutral yaw position may be defined by a non-inclined part of the ball support surface, for example extending parallel to the first mounting element and additionally or alternatively orthogonally to the central axis of yaw rotation. In such a non-inclined part, tension in the spring element does not cause the ball element to move and consequently also move the two mounting elements relative to each other. Alternatively to a non-inclined surface, the ball support surface may also comprise a channel to define a resting place for the ball element and the neutral position. Additionally or alternatively, the ball support surface may also comprise two surface parts inclined opposite to each other, for example forming a V-shaped ball support surface, which define a neutral position in between, for example at the bottom of the V-shape.

The two mounting elements may be plastic parts, for example manufactured in an injection-molding process. The first mounting element and alternatively or additionally the second mounting element may be configured as a bushing. The two mounting elements may therefore be lightweight and cost-effective to manufacture. Compared to other mounting devices, the present mounting device may have a low number of parts. Overall, the mounting device may have a high number of standard components instead of customized components. Further, the section of the mounting device with moveable parts and surfaces moveably relative to each other can easily be sealed with a seal between the two components or a top cap. In addition, the return force may be easily adapted by using different spring elements, preloading the spring element differently in the neutral yaw position and adjusting the profile of the inclined part of the ball support surface. Further, the size of the mounting device, for example an extension along the central axis, may be minimized by increasing the number of balls and corresponding spring elements.

In a further embodiment of the mounting device according to the first aspect, the mounting device is configured so that the ball element moves along the inclined part of the ball support surface such that the ball element compresses the spring element when rotating of the stick element about the central axis out of the neutral yaw position. For example, the ball element may roll, slide or move with a combination of sliding and rolling along the ball support surface when the joystick is rotated about the yaw axis and thus the two mounting elements rotate relative to each other. The ball element moves back, for example in a similar manner, when releasing the stick element in a deflected position, due to the spring element decompressing and imparting the stored energy on the ball element and the two mounting elements.

In a further embodiment of the mounting device according to the first aspect, starting from the neutral yaw position, the inclined part of the ball support surface is inclined towards the first mounting element in a circumferential direction relative to the central axis. For example, when following the inclined part of the ball support surface in a circumferential direction away from a point or area corresponding to the neutral yaw position, the distance to the first mounting element decreases. The point or area corresponding to the neutral yaw position may be the point or area of the ball support surface that contacts the ball element in the neutral yaw position. The inclined part of the ball support surface may be planar or curved to either provide for a linear increase in the return force or non-linear increase in the return force. The circumferential direction may, for example, be defined by an axis of symmetry of the second mounting element and additionally or alternatively by the central axis. The complete inclined part of the ball support surface may be inclined towards the first mounting element.

In a further embodiment of the mounting device according to the first aspect, the inclined part of the ball support surface is at least partially inclined away from the first mounting element in a radial direction relative to the central axis. For example, when following the inclined part of the ball support surface in a radial direction outward from the central axis, the distance to the first mounting element increases. The radial inclination of the ball support surface away from the first mounting element may provide smoother ball element movement and thus smoother joystick actuation. Further, such a radial inclination of the ball support surface away from the first mounting element may guide the ball element, thus avoiding bending of the spring element without requiring tight manufacturing tolerances and additionally or alternatively additional guiding elements.

In a further embodiment of the mounting device according to the first aspect, the second mounting element forms a receptacle for receiving the ball element. For example, the second mounting element may form a through shaped inner space for receiving the ball element. The ball element may thus be securely received. Further, assembly of the mounting device may be facilitated. The ball support surface of the second mounting element may form a bottom of the receptacle. The second mounting element may form a side wall for the receptacle. The side wall may extend in a direction substantially parallel to the central yaw axis. The bottom of the receptacle may extend transverse to the central yaw axis.

In a further embodiment of the mounting device according to the first aspect, the side wall of the second mounting element forms an end stop limiting rotation of the stick element of the joystick about the central axis of yaw rotation. The end stop may limit yaw rotation of the joystick. No additional parts are required for providing such an end stop. The mounting device may comprise two end stops for limiting the yaw rotation in both directions. Both end stops may be formed by the side wall of the second mounting element. One of the end stops may also be configured to prevent yaw rotation in one direction, for example by being arranged directly adjacent to the point or area of the ball support surface corresponding to the neutral yaw position.

In a further embodiment of the mounting device according to the first aspect, the first mounting element forms a lid for the receptacle. For example, a wall of the first mounting element may form a ceiling of the receptacle. The first mounting element may thus prevent that the ball element can fall out of the receptacle. Moreover, such a configuration allows easy sealing of the mounting device, for example by providing a seal between the side wall of the second mounting element and the wall of the first mounting element forming the lid of the receptacle. The seal may be arranged radially outside of the side wall of the second mounting element and additionally or alternatively outside of the receptacle for the ball element.

In a further embodiment of the mounting device according to the first aspect, the mounting device comprises an interface element arranged at a ball element facing side of the spring element. The spring element may urge against the ball element via the interface element, for example instead of directly touching the ball element. The interface element may allow smoother rolling of the ball element, for example by having a concave shape formed correspondingly to the sphere shape of the ball element. Further, the interface element may be formed from a different material than the spring element, such as a material having less friction with the ball element. The interface element may have an attachment section configured for attachment with the spring element, such as a pin shaped section for insertion into the spring element. The interface element may have a ball element contacting section, for example having a curved shape configured for contacting the ball element. The ball element contacting section of the interface element may project from the spring element towards the ball element.

In a further embodiment of the mounting device according to the first aspect, the mounting device comprises a further spring element and a further ball element. For example, the mounting device may comprise a first spring element, a second spring element, a first ball element and a second ball element. The mounting device may also comprise three ball elements and three spring elements or four ball elements and four spring elements or more. The spring elements may be configured identical to each other. The ball elements may be configured identical to each other. Using identical parts may reduce overall costs. The spring elements may be arranged symmetrically with respect to the central yaw axis.

The spring elements may be mounted to the first mounting element, each spring element urging a respective one of the ball elements against the ball support surface of the second mounting element. For example, each spring element may be pressing against an associated one of the ball elements. Rotation of the stick element about the central axis out of the neutral yaw position may cause increase of tension in both spring elements, providing the return force for rotating the stick element back into the neutral position upon release. The spring elements with the respective ball elements may be arranged symmetrically with regard to the central axis. The longitudinal extension of the mounting device along the central axis may be shorter due to the additional spring elements and ball elements providing the return force. Additionally or alternatively, a stronger return force may be provided with the additional spring elements and ball elements. There may be a corresponding inclined part of the ball support surface for each ball element with the associated spring element. The ball elements may be received in the same or separate receptacles. Features, configurations and advantages detailed above for the spring element and the ball element may equally apply to any additional spring elements and any additional ball element.

In a further embodiment of the mounting device according to the first aspect, the mounting device comprises a seal element arranged between the two mounting elements. Said seal element may prevent water and dirt ingress into the interior of the joystick, such as in the receptacle for ball elements. Due to the design of the mounting device, a low number of seals and additionally or alternatively standard seal elements may be used. The seal element may be an annular seal. The seal element may be configured as a rotary seal. The rotary seal may allow the two mounting elements to rotate relative to each other around the central axis while maintaining the sealing effect. The seal element may comprise a sealing lip. For example, the seal element may comprise just one sealing lip. The seal element may be formed from a compliant material, such as rubber. The mounting device may comprise only a single rotary seal element which allows relative rotational movement about the central axis while sealing. The seal element may be symmetrical with regard to the central axis.

One of the two mounting elements may provide a seal support surface on an outer side of the one of the two mounting elements. For example, said one of the two mounting elements may comprise regularly spaced apart ribs protruding radially outside from the side wall limiting the receptacle. The seal support surface may be an integral part of said one of the two mounting elements and may be manufactured together with the rest of the mounting element in a cost-effective injection molding process. For example, the second mounting element may comprise the seal support surface. The seal element may rest on the seal support surface. The seal element may seal against the seal support surface or against the side wall. The seal support surface may be formed by a plurality of ribs spaced around the circumference of the one of the two mounting elements. Such a configuration is lightweight. The seal support surface may be an annular surface or a surface with discrete sections formed by the rips. The seal element may seal against a ledge on the other one of the two mounting elements.

In a further embodiment of the mounting device according to the first aspect, the mounting device comprises a support element that rotatably fixes the two mounting elements to each other. For example, one or both of the mounting elements may comprise a central through hole or blind hole forming a receiving space for the support element in which the support element is inserted. The support element may be tightened against the mounting elements by means of a screw. The support element may partially form the bottom of the receptacle and additionally or alternatively the side wall of the receptacle. For example, the support element may have a cylindrical shape with a longitudinal axis coaxial with the central yaw axis. The support element may rotatably support the mounting elements on each other. The support element may be formed from an autolubricating plastic. An autolubricating plastic may not require additional lubrication. Such a configuration may prolong maintenance intervals and may render greasing the mounting device superfluous.

In a further embodiment of the mounting device according to the first aspect, the first mounting element is an injection molded plastic part. Alternatively or additionally, the second mounting element is an injection molded plastic part. With such a configuration, the mounting device may be cost-effective to manufacture in high quantities.

A second aspect relates to a joystick. The joystick may be configured for controlling a vehicle. The joystick comprises a mounting device according to the first aspect and a stick element fixed to one of the two mounting elements.

In a further embodiment of the joystick according to the second aspect, the joystick comprises a base element configured for mounting to the vehicle. The base may also allow forward, backward, left and right tilting of the stick element besides the yaw rotation capability provided by the mounting device. The one of the two mounting elements without the stick element fixed thereto may be mounted to the base element, for example tiltable mounted. The joystick may comprise a sensor element configured to capture rotation of the two mounting elements relative to each other about the central axis of yaw rotation.

A third aspect relates to a marine vehicle with a thruster. The thruster may be moveable relative to a hull of the marine vehicle. For example, the marine vehicle may be a speedboat and the moveable thruster an outboard motor. As a further example, the marine vehicle may be a ship and the moveable thruster may be a thruster pod extending from the hull of the marine vehicle. As another further example, the thruster may be a lateral thruster fixedly installed in the hull. The joystick may be configured to control the thruster corresponding to a rotation of the stick element about the central axis. For example, yaw movement of the stick element may control a thrust output of the lateral thruster. As another example, yaw movement of the stick element may control tilt movement of the outboard motor or control swiveling of the thruster pod. Other movements of the stick element, such as forward and backward tilting, may control different vehicle functions, such as different thrusters and additionally or alternatively different settings of the thruster. The marine vehicle may be very easy and intuitive to control with the joystick having the cost-effective mounting device.

Preferred embodiments and expedient developments of one aspect may also constitute preferred embodiments and expedient developments of the other aspects. Other features of the present invention will be apparent from consideration of the information contained above as well as in or in combination with the following detailed description, drawings and claims.

### BRIEF DESCRIPTION OF THE DRAWINGS

FIG. 1 schematically illustrates a joystick in a top view.

FIG. 2 schematically illustrates the joystick of FIG. 1 in a front way, wherein the joystick is partially shown in a sectional view to illustrate details of a mounting device.

FIG. 3 schematically illustrates the joystick of FIG. 1 in a side way, wherein the joystick is partially shown in a sectional view to illustrate details of the mounting device.

FIG. 4 schematically illustrates in a sectional side view the mounting device in its neutral yaw position.

FIG. 5 schematically illustrates in another sectional side view the mounting device in the neutral yaw position.

FIG. 6 schematically illustrates in a top view the mounting device in the neutral yaw position.

FIG. 7 schematically illustrates in a sectional side view the mounting device in one of its limit yaw positions.

FIG. 8 schematically illustrates in another sectional side view the mounting device in the limit yaw position of FIG. 7.

FIG. 9 schematically illustrates in a top view the mounting device in the limit yaw position of FIG. 7.

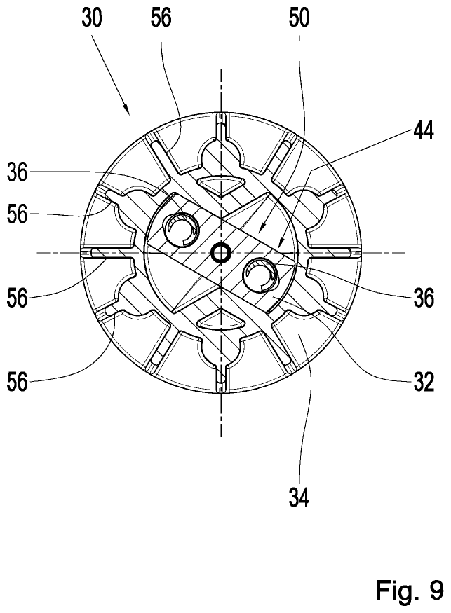

FIG. 10 shows some of the parts of the mounting device in an exploded view.

### DETAILED DESCRIPTION OF EMBODIMENTS

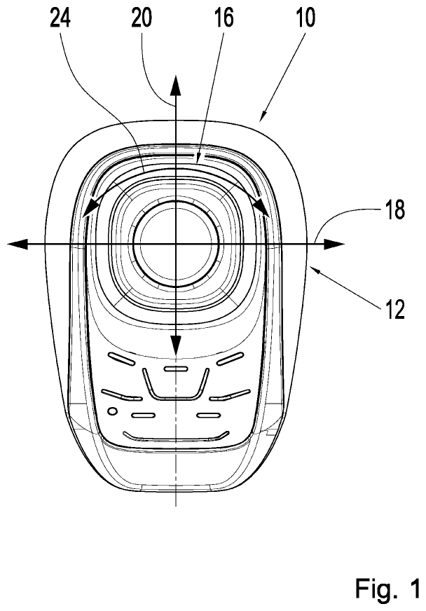

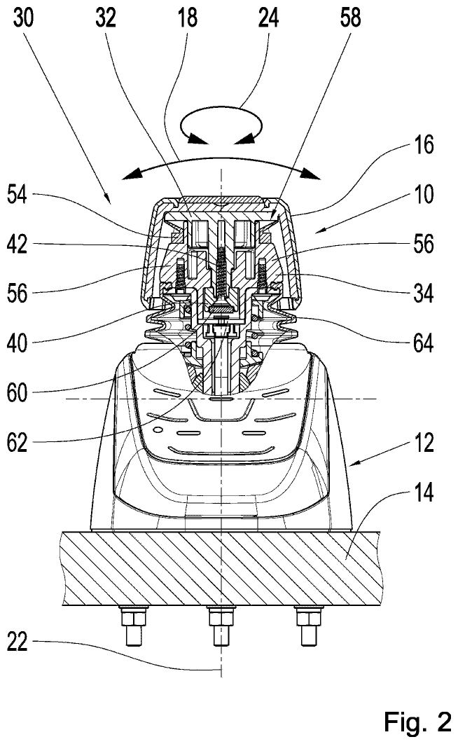

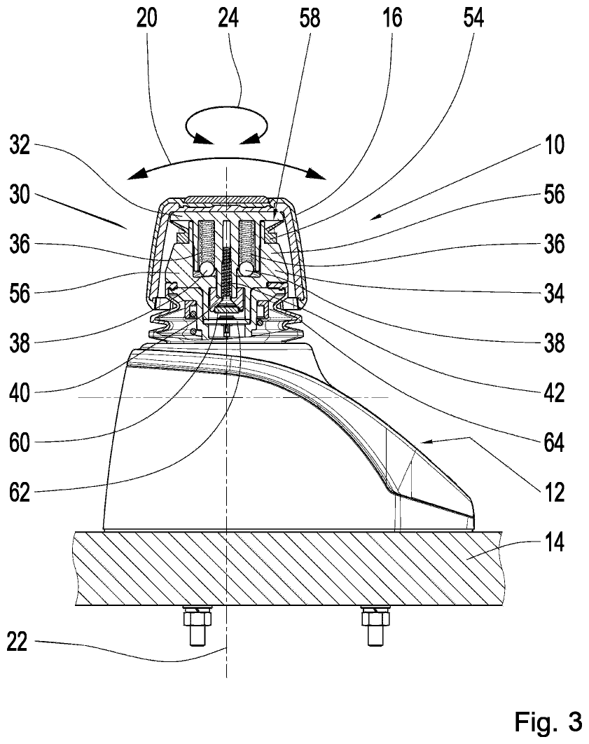

FIG. 1 shows a joystick 10. The joystick comprises a base 12 that is bolted to a deck 14 of a marine vessel. Further, the joystick comprises a stick element 16 that is moveably attached to the base 12. The stick element 16 is shaped as a cap, which can best be seen in FIG. 2 and FIG. 3. The stick element 16 can be tilted relative to the base 12 in a left-right direction out of a neutral yaw position, which is shown in FIGS. 1 to 3. The left-right tilting is illustrated with arrow 18. The left-right tilting is a swaying of the joystick 10. The stick element 16 can be tilted relative to the base 12 in a forward-backward direction out of the neutral yaw position. The forward-backward tilting is illustrated with arrow 20. Further, the stick element 16 can be rotated relatively to the base 12 around a central axis 22 of yaw rotation, which corresponds to a longitudinal central axis of the stick element 16 in the shown example. The yaw rotation is illustrated with arrow 24.

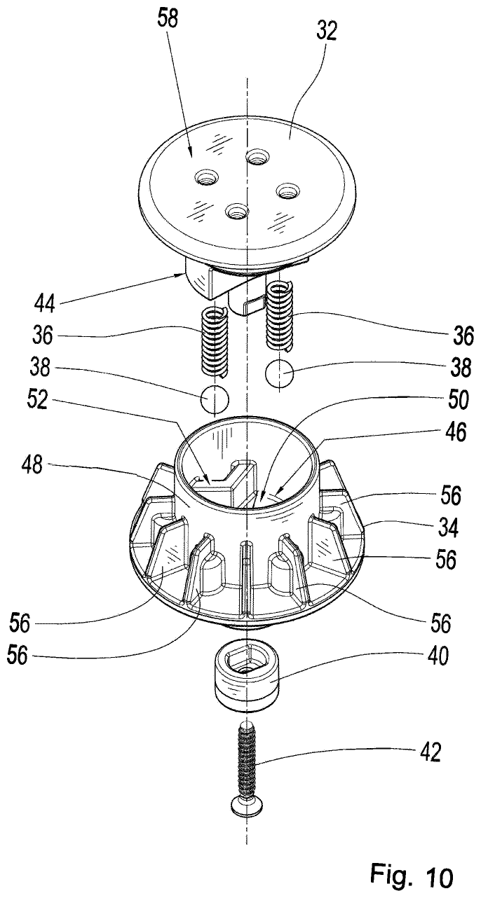

To provide the possibility for yaw rotation while also providing a bias for the stick element 16 to automatically return to the neutral yaw position upon release of the joystick 10, the joystick 10 comprises a mounting device 30. The mounting device 30 comprises a first mounting element 32, a second mounting element 34, two spring elements 36 and two ball elements 38, as can be seen in the exploded view of FIG. 10.

The stick element 16 is attached to the first mounting element 32, for example with screws. The second mounting element 34 is fixed to the base 12. In another embodiment, the arrangement is reversed. The two mounting elements 32, 34 are rotatably attached to each other to allow a rotation of the stick element 16 of the joystick 10 about the central axis 22 of yaw rotation out of the neutral yaw position. For this purpose, the mounting device 30 comprises a support element 40 and a screw 42 that attaches the two mounting elements 32, 34 relatively rotatable to each other.

Both mounting elements 32, 34 are injection molded parts. The spring elements 36 and the ball elements 38 are standard parts. The spring elements 36 are received each in a corresponding blind hole in the first mounting element 32 that are symmetrically arranged in a projection 44 of the first mounting element 32 and parallel to the central axis 22. The projection 44 of the first mounting element 32 is arranged in a receptacle 46 formed by the second mounting element 34. The receptacle 46 is limited in the radial direction by a side wall 48 of the second mounting element 34. The receptacle is closed by the first mounting element 32, which forms a lid for the receptacle 46.

The spring elements 36 are mounted to the first mounting element 32 and urge each a corresponding one of the ball elements 38 against a ball support surface 50 of the second mounting element 34. The ball support surface 50 forms a bottom of the receptacle 46. The ball elements 38 are received in the receptacle 46 and rest on the ball support surface 50.

At least a part of the ball support surface 50 is inclined such that rotation of the stick element 16 about the central axis 22 away from the neutral yaw position causes increase of tension in the spring elements 36 since the ball elements 38 are moved closer to the first mounting element 32 and thus against the spring elements 36, providing a return force for rotating the stick element 16 back into the neutral position upon release of the stick element 16.

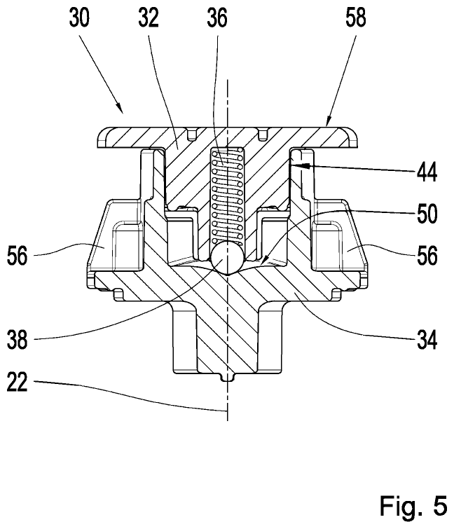

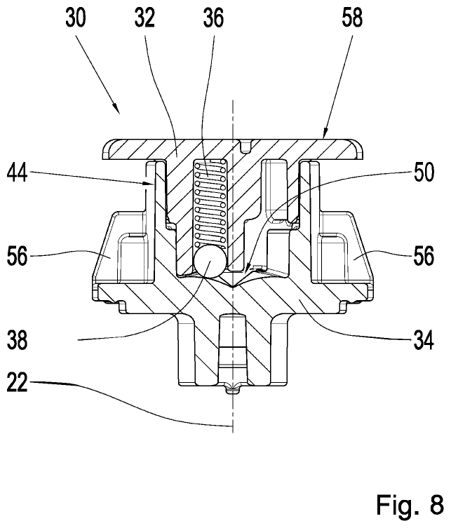

Said inclination can best be seen in FIG. 5, showing one of the ball elements 38 resting on a section of the ball support surface 50 corresponding to the neutral yaw position. In both circumferential directions, the ball support surface comprises an inclined part inclined toward the first mounting element 32. In the sectional view of FIG. 5, this results in a V-shaped ball support surface 50 with the bottom of the V-shape corresponding to the neutral yaw position. When twisting the stick element 16 and thus the first mounting element 32 around the central yaw axis 22, the ball elements 38 are moved upwards in a direction parallel to the central axis 22 toward the first mounting element 32 and against the spring elements 36. Such a position can be seen in FIG. 8, illustrating the maximum angle of yaw rotation in one direction, corresponding to a limit position. The energy stored in the compressed spring elements 36 cause the spring elements 36 to push against the ball elements 38, moving the ball elements 38 down the inclined part of the ball support surface 50 toward the section corresponding to the neutral yaw position upon joystick 10 release, thus also causing the stick element 16 and the first mounting element 32 to rotate back towards their neutral yaw position.

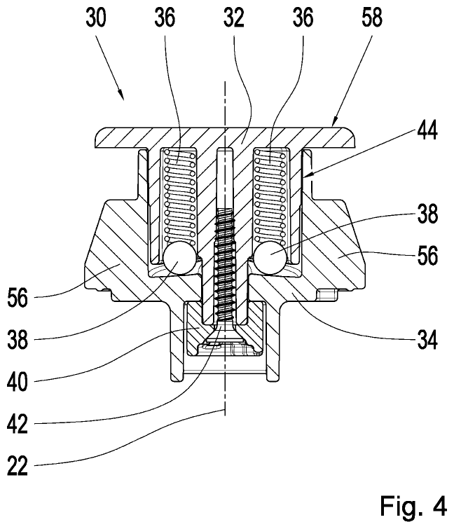

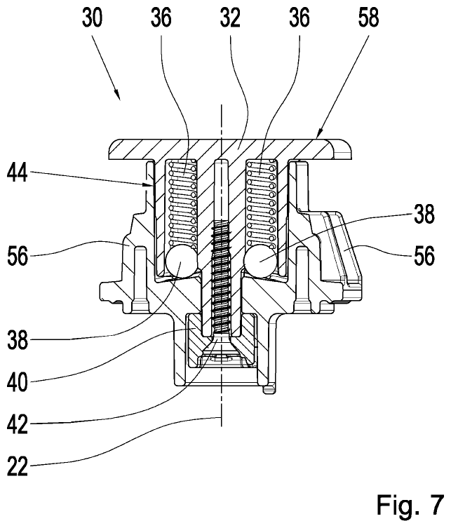

In an embodiment, the inclined part of the ball support surface 50 is at least partially inclined away from the first mounting element 32 in a radial direction relative to the central axis 22. This can best be seen in FIG. 4 and FIG. 7, showing a downward tilted ball support surface. Such a configuration improves smooth movement of the ball elements 38 and therefore the mounting elements 32, 34 relative to each other. Further, in some embodiments, as can also be seen in FIG. 4 and FIG. 7, the ball elements 38 are partially received in the blind hole in which the corresponding spring element 36 is received. The first mounting element 32 thus guides the ball elements 38 in the receptacle during yaw movement of the two mounting elements 32, 34 relative to each other, further improving smoothness of movement.

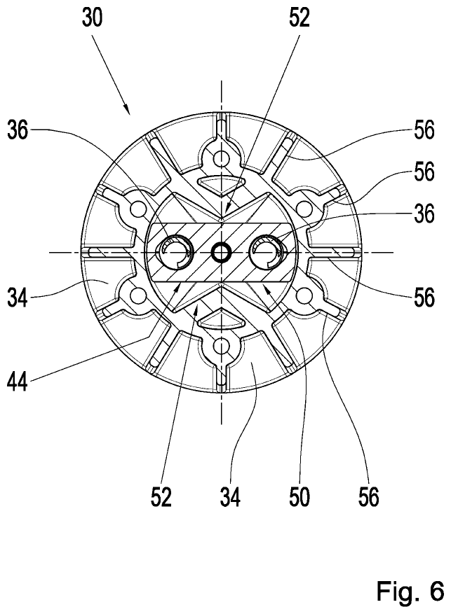

The side wall 48 of the second mounting element 34 forms an end stop limiting rotation of the stick element 16 of the joystick 10 about the central axis 22 of yaw rotation. For that purpose, the side wall 48 has two projections 52 projecting inwards in the receptacle 46. In the neutral yaw position of the first mounting element 32, the projections 52 are equidistantly spaced apart from the projection 44 of the first mounting element. This can best be seen in FIG. 6. When rotating the stick element 16 about the central axis 22, the projection 44 of the first mounting element 32 will rest at least with one side against at least one of the projections 52, which defines an end stop and thus the maximum angle of yaw rotation. In other embodiments, the projections 52 of the side wall 48 are not equidistantly spaced apart from the projection 44 of the first mounting element 32. For example, when at least one of the projections 52 of the side wall 48 are in contact with one side of the projection 44 of the first mounting element 32 in the neutral yaw position, it is only possible to rotate the stick element 16 in one direction around the central axis 22 of yaw rotation.

The mounting device comprises an annular rotary seal 54, which can best be seen in FIG. 2 and FIG. 3. The seal 54 rests on ribs 56 of the second mounting element 34 spaced around an outside of the side wall 48. The ribs 56 form a discontinuous seal support surface. The seal 54 is tightly fitting against the section of the side wall 48 projecting longitudinally beyond the ribs 56 towards the first mounting element 32. The seal 54 comprises one annular lip that seals against a ledge 58 of the first mounting element 32 projecting radially. Further, the joystick comprises an annular seal 64 having folds. The seal 64 seals between the base 12 and the mounting device 30, in the shown example against the second mounting element 34.

The joystick 10 comprises a sensor 60 arranged in a longitudinal direction beneath the second mounting element 34, such as a magnet sensor system or potentiometer. Further, the joystick 10 comprises a PCB board 62. The sensor 60 is configured to capture a yaw rotation of the stick element 16 or to capture rotation of the two mounting elements 32, 34 relative to each other about the central axis 22 of yaw rotation. The PCB board 62 is configured to transmit a sensor signal. Further, in an embodiment, the PCB board 62 is configured to generate a control signal for controlling a thruster of the marine vessel.

The mounting device 30 uses a lot of standard parts and injection molded parts and may thus be manufactured cost-effectively in high numbers. Further, high forces for returning the stick element 16 in its neutral yaw position may be provided in a very small space. The force may be easily adapted with different spring elements, a different number of spring elements 36 and ball elements 38 different inclinations and different profiles of the ball support surface 50. The mounting device 30 can easily be sealed against a maritime environment.

### LIST OF REFERENCE SIGNS

10 joystick
12 base
14 deck
16 stick element
18 arrow: left-right tilting
20 arrow: forward-backward tilting
22 central axis of yaw rotation
24 arrow: yaw rotation
30 mounting device
32, 34 mounting elements
36 spring elements
38 ball elements
40 support element
42 screw
44 projection
46 receptacle
48 side wall
50 ball support surface
52 projections
54 rotary seal
56 ribs
58 ledge
60 sensor
62 PCB board
64 annular seal

1. A mounting device (30) for a joystick (10) having a stick element and configured for controlling a vehicle, the mounting device (30) comprising:
a first mounting element (32);
a second mounting element (34);
a spring element (36); and
a ball element (38);
wherein the first and second mounting elements (32, 34) are rotatably attached to each other to allow a rotation of the stick element (16) of the joystick (10) about a central axis (22) of yaw rotation out of a neutral yaw position;
wherein the spring element (36) is mounted to the first mounting element (32) and urges the ball element (38) against a ball support surface (50) of the second mounting element (34);
wherein the ball support surface (50) includes an inclined portion configured such that rotation of the stick element (16) about the central axis (22) away from the neutral yaw position causes increase of tension in the spring element (36), providing a return force for rotating the stick element (16) back into the neutral position upon release.

2. The mounting device (30) according to claim 1, wherein the mounting device (30) is configured so that the ball element (38) can move along the inclined part of the ball support surface (50) such that the ball element (38) compresses the spring element (36) when rotating of the stick element (16) about the central axis (22) out of the neutral yaw position.

3. The mounting device (30) according to claim 1, wherein starting from the neutral yaw position, the inclined portion of the ball support surface (50) is inclined towards the first mounting element (32) in a circumferential direction relative to the central axis (22).

4. The mounting device (30) according to claim 1, wherein the inclined portion of the ball support surface (50) is at least partially inclined away from the first mounting element (32) in a radial direction relative to the central axis (22).

5. The mounting device (30) according to claim 1, wherein the second mounting element (34) defines a receptacle (46) configured for receiving the ball element (38), wherein the ball support surface (50) forms a bottom of the receptacle (46) and wherein the second mounting element (34) forms a side wall (48) for the receptacle (46).

6. The mounting device (30) according to claim 5, wherein the side wall (48) of the second mounting element (34) forms an end stop limiting rotation of the stick element (16) of the joystick (10) about the central axis (22) of yaw rotation.

7. The mounting device (30) according to claim 5, wherein the first mounting element (32) forms a lid for the receptacle (46).

8. The mounting device (30) according to claim 1, wherein the mounting device (30) comprises an interface element arranged at a side of the ball element (38) facing the spring element (36), and wherein the spring element (36) urges against the ball element (38) via the interface element.

9. The mounting device (30) according to claim 1, wherein the spring element (36) is a first spring element, the ball element (38) is a first ball element, and the mounting device (30) comprises a second spring element (36) and a second ball element (38);
wherein the first and second spring elements (36) are mounted to the first mounting element (32), each of the first and second spring elements (36) urging a respective one of the first and second ball elements (38) against the ball support surface (50) of the second mounting element (34);
wherein rotation of the stick element (16) about the central axis (22) out of the neutral yaw position causes increase of tension in both of the first and second spring elements (36), providing the return force for rotating the stick element (16) back into the neutral position upon release; and
wherein the first and second spring elements (36) with the respective first and second ball elements (38) are symmetrically arranged with regard to the central axis (22).

10. The mounting device (30) according to claim 1, comprising:
a seal element (54) arranged between the two mounting elements (32, 34), wherein one of the first and second mounting elements (32, 34) forms a seal support surface on an outer side thereof, and wherein the seal support surface is formed by a plurality of ribs (56) spaced around the circumference of the one of the first and second mounting elements (32, 34).

11. The mounting device (30) according to claim 1, comprising a support element (40) configured to rotatably fix the first and second mounting elements (32, 34) to each other, wherein the support element (40) is formed from an autolubricating plastic.

12. The mounting device (30) according to claim 1, wherein the first mounting element (32) is an injection molded plastic part and the second mounting element (34) is an injection molded plastic part.

13. A joystick (10) configured for controlling a vehicle, the joystick (10) comprising a mounting device (30) according to claim 1 and a stick element (16) fixed to one of the two mounting elements (32, 34).

14. The joystick (10) according to claim 13, comprising:
a base element (12) configured for mounting to the vehicle, wherein the one of the first and second mounting elements (32, 34) without the stick element (16) fixed thereto is mounted to the base element (12); and
a sensor (60) element configured to capture rotation of the first and second mounting elements (32, 34) relative to each other about the central axis (22).

15. A marine vehicle with a moveable thruster and a joystick (10) according to claim 13, wherein the joystick (10) is configured to control the thruster corresponding to a rotation of the stick element (16) about the central axis (22) of yaw rotation.

16. The marine vehicle of claim 15, comprising:
a base element (12) configured for mounting to the vehicle, wherein the one of the first and second mounting elements (32, 34) without the stick element (16) fixed thereto is mounted to the base element (12); and
a sensor (60) element configured to capture rotation of the first and second mounting elements (32, 34) relative to each other about the central axis (22).
